(19) United States
(12) Patent Application Publication
(10) Pub. No.: US 2002/0199197 A1
(43) Pub. Date: Dec. 26, 2002

(54) System for exchanging data

(76) Inventors: Marco Winter, Hannover (DE); Andrei Chevtsov, Hannover (DE)

Correspondence Address: Joseph S Tripoli, Thomson Multimedia Licensing, CN 5312, Princeton, NJ, 08540-0028, US

(21) Appl. No.: 10/149,785

(22) PCT Filed: Dec. 7, 2000
(86) PCT No.: PCT/EP00/12341

(30) Foreign Application Priority Data
Dec. 20, 1999 (DE) 19960741.9

(51) Int. Cl. H04N 7/18

(52) U.S. Cl. 725/74

(57) ABSTRACT

The present invention relates to a system for exchanging data between a data provider and a data user. The starting point for the invention is a system which is known by the term “video on demand”. The system according to the invention affords a user significantly further-reaching possibilities in that the user can control from home the recordings which he intends to have stored in a database of the provider. These recordings may be, in principle, any desired data which the provider receives by various routes, e.g. via cable connection, satellite antenna, Internet, etc.

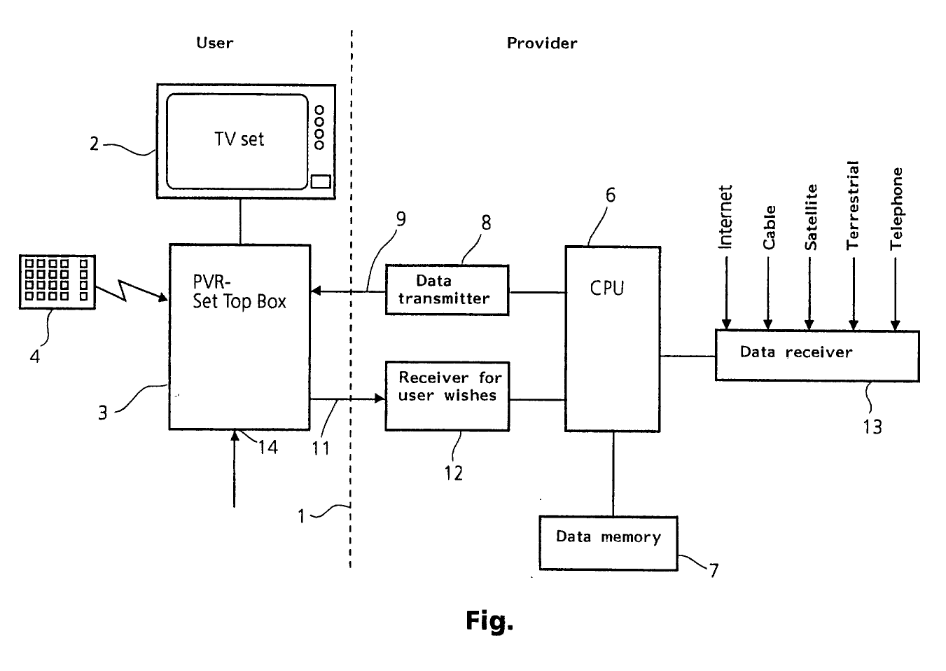

The invention relates to a system for exchanging data between a data provider and a data user. In particular, the invention relates to a system in which a provider makes video data available to a user.

Systems of this type are already known by the term “video on demand”. An additional receiving device, which is also referred to as a set-top box, enables the user of a video on demand system to establish a connection to the database of the provider. With the aid of a menu selection, a specific film can be selected from hundreds of films according to title, genre or actor simply by clicking on a specific line on a list. The viewer can view the film directly after selecting it on the domestic television set. Furthermore, additional information can also be obtained using this system, such as e.g. the fee paid to the provider, the running time of the film, details about actors or information about the contents of the film. The films offered are present as digitized recordings on hard-disk storage devices, as are known from the computer industry. A sophisticated data server technology makes it possible even today to transmit hundreds of films simultaneously to thousands of households. Despite the great diversity, the users' selection remains restricted to films made available by the provider.

A different route is taken by the “personal TV receiver” or PTV, that is to say a personal or individualized television set. The PTV is connected between the conventional TV set and an antenna input or a set-top box. At the same time, the PTV is connected to a telephone line. The PTV is equipped with a hard-disk storage device on which the received television transmissions are digitized, e.g. according to the MPEG II Standard, and stored. The hard-disk storage device opens up new possibilities for a user, which the latter does not have with a conventional magnetic tape video recorder. Thus, by way of example, it is possible to interrupt transmissions that are currently being broadcast for a while and resume viewing the transmission exactly at the same location after the interruption. In such a case, the PTV records the transmission that is presently being broadcast on hard disk and simultaneously reproduces the transmission with a time offset. Furthermore, a user can mark a specific transmission of a series simply by pressing a button, and the PTV will automatically record all transmissions in this series. Moreover, the system also records other transmissions that might be of interest to the user according to a user profile created by the provider. In order to make this possible, the PTV is called by the provider during the night, whereupon the current program information is then interrogated and the PTV is programmed accordingly.

Despite many new possibilities and a high degree of flexibility, the user of this system is restricted in his selection to transmissions that he can receive at home using the technical means available to him.

Taking this as a departure point, the object of the invention is to provide a system for exchanging data between a provider and a user which preserves all the advantages of the systems described in the introduction but avoids the disadvantages thereof.

This object is achieved by means of a system according to claim 1, which is characterized in that in a manner dependent on received user commands the central control unit stores data from the data receiver in the data memory whilst establishing a unique reference to the individual user and/or forwards them to the user unit via the data transmitter.

One advantage of the system according to the invention is that a user can access all transmissions which can be received by the corresponding provider. Since the reception possibilities for a commercial provider naturally far exceed those for a private household, the user has virtually unlimited possibilities for recording or directly receiving transmissions.

The data memory required for this may expediently be constructed from individual data storage devices in order to increase its operational reliability. The data storage devices may contain magnetic hard disks, for example. A particular advantage of the invention is that the data receiver can receive data from various sources, such as e.g. television and broadcast channels disseminated via cable, satellite or terrestrially, and, furthermore, data which are received via an Internet connection or a telephone line.

In order to utilize storage capacities in the data memory as efficiently as possible, one and the same transmission can be stored for a plurality of users, the reference to the individual users being established by pointers to this transmission. Such pointers are known from data technology.

In a cost-effective embodiment of the invention, the data connection between the user and the provider may be established by a telephone line which enables a sufficiently high data rate.

In a particularly expedient embodiment of the invention, the user unit is equipped with an interface which allows the exchange of data with at least one further connected device. This means that it is possible, for example, to transmit video data from a camcorder, which has a corresponding interface, to the set-top box and, from there, to communicate the video data to the provider, where the data are finally stored in a data memory. It is advantageous if the said interface is designed as an IEEE 1394 interface. The IEEE 1394 interface can provide the preconditions for linking the set-top box into a network. In such a case, all the possibilities which the provider has with regard to data storage, management of data and access to data are available to the user for all the devices linked into the network.

The single figure of the drawing schematically illustrates one exemplary embodiment of the invention.

The invention's system for exchanging data is essentially structured in two parts, which is indicated by the broken line 1 in the figure. At the user end the system comprises a conventional television set 2 connected to an additional receiving device 3, a so-called set-top box. The set-top box 3 can be controlled by means of operating elements or by means of a remote control 4.

At the provider end the system comprises a central control unit 6, which controls, inter alia, a data memory 7. The data memory may be constructed from a number of magnetic hard disks as are known from computer technology. The central control unit 6 is able to access a specific memory area and to transmit the stored data with the aid of a data transmitter 8 via a data line 9 to the set-top box 3 installed on the user's premises. Via a return channel 11, the user can communicate to a receiver for user wishes 12 the data to which access is desired. The central control unit 6 then makes the desired data available to the user. The system described thus far corresponds to known systems referred to by the term “video on demand”. At the provider end the system corresponds to a data server which enables digital data to be simultaneously stored, read out and distributed to a plurality of users. A system of this type is disclosed e.g. in U.S. Pat. No. 5,920,702. In the case of this system, the user can choose from a selection of films made available on the data server. In this respect, this system corresponds to a video library having a predetermined and limited selection.

Furthermore, the system according to the invention also has a data receiver 13 which is suitable for receiving television and broadcast channels from various sources. These sources include an Internet, telephone and cable connection, a satellite antenna and a terrestrial antenna. It goes without saying that even more of the sources mentioned or other sources as well may be present. The data receiver 13 can likewise be controlled by the central control unit 6 and thereby opens up entirely new possibilities to the user which go far beyond what can be accomplished by conventional video on demand systems. By way of example, the user can communicate a recording wish to the receiver 12 via the return channel 11, so that the central control unit 6 drives the data receiver 13 in such a way that a very specific transmission is stored in the data memory 7. This means that the possible options for a user are no longer restricted to a predetermined selection, but rather can be extended to all recordings stored by a provider and to all transmissions which can be received by a provider. Since the technical possibilities for a commercial provider far exceed those for a private household, the selection possibilities are naturally virtually unlimited. By way of example, it is conceivable that American citizens staying in Europe for a while could receive local news from a specific region in the USA in this way. This presupposes merely that the provider has access to the transmission material, which is readily possible e.g. via an Internet connection or a data line.

Since the data server handles numerous tasks simultaneously, i.e. operates in parallel, memory space can be saved to a considerable extent if a film is recorded only once but this one recording is assigned to a plurality of users by means of so-called pointers and/or time stamps. By way of example, Herr Müller and Herr Meier recorded yesterday's news. However, the news was actually stored only once, but there are two pointers pointing to this one recording. In this case, the pointers need not be identical, i.e. Herr Muller's recording starts at 19.59 and ends at 20.16, whereas the pointer assigned to Herr Meier points to the recording from 20.00 to 20.15.

In one exemplary embodiment of the invention, the data line 9 and the return channel 11 are realized by a telephone connection in the case of which the data line has e.g. a transmission rate of 10 megabits per second. A considerably lower data transmission rate suffices for the return channel as long as the return channel is utilized only for control purposes. As soon as the return channel is also used to transmit extensive data (e.g. audio and video data), the return channel must allow a higher data rate. This may be the case, for example, when a camcorder is connected to a schematically illustrated interface 14 of the set-top box in order to copy recordings from the camcorder to the data memory 7 of the provider.

In one exemplary embodiment of the invention, the interface 14 may be designed as an IEEE 1394 interface. In this way, it is possible to link the set-top box 3 into a domestic network. What this achieves at the same time is that all the devices integrated in the domestic network are connected to the system of the provider, in particular to the data memory 7.

In a further exemplary embodiment of the invention, the modem which establishes a connection to the provider is not integrated in the set-top box but rather is made available by the network. This embodiment affords the advantage that it is not necessary to install the set-top box 3 in the vicinity of a telephone connection.

With the new system, the user can start and end recording of a current transmission directly or else program recording at a later time. Furthermore, it is also possible for the user to actively manage his personal archive at the provider, i.e. edit already recorded transmissions, e.g. erase advertising blocks, erase entire transmissions, or mark transmissions of particular interest. Finally, it is also possible, as in the case of a conventional video on demand system to reproduce a transmission from the provider's archive which the user did not request to be recorded at an earlier time.

Without appreciable technical changes to the devices in the system, it is also possible to call up from, or store at, the provider not only video data but also audio data, software or electronic books.

Since the additional receiving device required on the user's premises no longer has any mechanical components at all, it is small, light, robust and inexpensive compared with a conventional video recorder or a hard-disk recorder. Furthermore, there is no longer any need at all for the user to conform to new storage media through new purchases. Moreover, the user has the possibility of always accessing the latest software programs for managing his personal archive.

1. System for exchanging data between a data provider and a data user, at the user end the system having a user unit (3) which is connected to the provider via a data line (9, 11) and allows the reception of data from the provider and the transmission of data and/or user commands to the provider, and at the provider end the system comprising a central control unit (6) which controls a data memory (7), a data transmitter (8) and also a receiver for user commands (12), characterized in that at the provider end the system additionally has a data receiver (13) which is controlled by the central control unit (6), and in that in a manner dependent on received user commands the central control unit (6) stores data from the data receiver (13) in the data memory (7) whilst establishing a unique reference to the individual user and/or forwards them to the user unit (3) via the data transmitter (8).

2. System according to claim 1, characterized in that the data memory (7) is constructed from a number of individual data storage devices.

3. System according to claim 2, characterized in that the individual devices contain at least one magnetic hard disk.

4. System according to claim 1, characterized in that the data receiver (13) is set up in such a way that data can be received from various sources.

5. System according to claim 4, characterized in that the sources are selected from the following group: Internet, cable channel, satellite channel, terrestrially transmitted broadcast channel, and telephone connection.

6. System according to claim 1, characterized in that the unique reference between a data content in the data memory (7) and a specific user is established by pointers in the data memory.

7. System according to claim 6, characterized in that the pointer is realised as a memory address or as a time stamp.

8. System according to claim 1, characterized in that the data line between the user and the provider is a telephone line.

9. System according to claim 1, characterized in that the user unit has an interface (14) which allows the connection of at least one further device in order to enable data transmission between this device or these devices and the provider.

10. System according to claim 9, characterized in that the interface (14) is designed as an IEEE 1394 interface.
